(19) United States
(12) Patent Application Publication
(10) Pub. No.: US 2016/0047284 A1
(43) Pub. Date: Feb. 18, 2016

(54) Apparatus and Method for Preventing and Removing Carbon Deposits

(71) Applicants: Luke J. Turgeon, Shillington, PA (US); Douglas Van Tiggelen, Bernville, PA (US)

(72) Inventors: Luke J. Turgeon, Shillington, PA (US); Douglas Van Tiggelen, Bernville, PA (US)

(21) Appl. No.: 14/823,092

(22) Filed: Aug. 11, 2015

Related U.S. Application Data
(60) Provisional application No. 62/036,193, filed on Aug. 12, 2014.

(51) Int. Cl. F01N 3/029; F01N 3/023; F02B 77/04; F01N 3/035

(52) U.S. Cl. CPC F01N 3/0293; F01N 3/035; F01N 3/0237; F02B 77/04

(57) ABSTRACT

Oxyhydrogen (HHO) generated by an HHO generator hydrogenates solid carbon to liquid and gaseous hydrocarbons in the exhaust system of an internal combustion engine, such as in the particulate filter of a diesel engine to clean the solid carbon from the particulate filter without conventional regeneration. Discharge of the HHO to the exhaust system also reacts with NOx in the exhaust gas to reduce the NOx. The HHO may be discharged to a plurality of locations to clean solid carbon and reduce NOx emissions from a diesel engine.

### I. RELATED APPLICATIONS

This application is entitled to priority from U.S. Provisional Application 62/036,193 filed Aug. 12, 2014 by Luke J. Turgeon and entitled “apparatus and method for preventing and removing carbon deposits,” which is incorporated by reference as if set forth in full herein. The following document also is incorporated by reference as if set forth in full herein: U.S. Pat. No. 8,852,410, entitled ‘Electrolytic hydrogen generator and method,’ issued Oct. 7, 2014 to Luke J. Turgeon et al.

### II. BACKGROUND OF THE INVENTION

A. Field of the Invention

The Invention is an apparatus and method for removing carbon and preventing the buildup of carbon, such as carbon deposits on particulate filters of diesel engines. The Invention also applies to the removal of carbon and prevention of the build-up of carbon on the internal engine components of diesel and gasoline engines, including cylinders, pistons, piston rings, piston ring grooves and exhaust system.

B. Statement of the Related Art

Beginning in 2007, new diesel truck engines in the U.S. were required to utilize emission controls comprising a particulate filter followed by injection of urea and a catalytic converter. The particulate filter catches soot, which is largely carbon, from the diesel engine and prevents the soot from blinding the catalytic converter or entering the ambient air. The urea (CO(NH₂)₂) is converted to ammonia (NH₃) above 125° F. The ammonia decomposes to hydrogen, which reacts in the catalytic converter with nitrogen oxides (NOₓ), a pollutant, chemically reducing the nitrogen oxides to nitrogen (N₂) and water (H₂O). The use of urea to control NOx requires that urea always be available and that the diesel truck always must carry a supply of urea.

As soot accumulates in the particulate filter, the pores of the filter become clogged and the pressure drop of the exhaust gases across the filter increases. When the pressure drop across the filter exceeds acceptable limits (about 2.5 inches of water), the on-board engine control system disables the vehicle so that the vehicle cannot be driven. The on-board control system then attempts to ‘regenerate’ the filter by injecting hot gasses resulting from combustion of fuel through the filter.

If the regeneration step is not successful in adequately reducing the pressure drop across the particulate filter, the filter must be serviced or replaced. The filter is serviced by blowing high-pressure air through the filter to dislodge the soot. The filter is then re-checked for pressure drop. If blowing air through the filter is not successful, the filter is heated in a kiln to oxidize some of the carbon, followed by re-application of the high-pressure air and re-testing of the pressure drop. If blowing out the soot and heating the filter are not successful in achieving an acceptable pressure drop, then the filter must be returned to the factory and replaced with a new filter.

Conventional regeneration, high-pressure air blowing and kiln-baking damages the structure of the particulate filter and shortens the life of its components. Conventional regeneration repeatedly heats the particulate filter to a very high temperature to incinerate the solid carbon contained within the filter. The resulting thermal stresses on the ceramic core and on the seals of the particulate filter plus the physical violence of high-pressure air blowing shorten the structural life of the filter.

Even if cleaning of the filter is successful, substantial carbon remains in the filter after cleaning and the useful life of the cleaned filter is uncertain. As a filter becomes more and more clogged, multiple service events may be required to deal with the clogged filter, with each service event providing only a temporary fix. Servicing and replacing the filter is a costly maintenance item for owners of diesel engines.

An additional issue with cleaning diesel engine particulate filters is that the ash resulting from regeneration of the filters is regulated as hazardous waste due to the metal content, which further increases the cost of cleaning the filters.

Carbon accumulates in other locations on a diesel or gasoline engine. For example, carbon from incompletely combusted fuel will accumulate on the piston and piston rings of a reciprocating engine. The build-up of the carbon over time interferes with the operation of the engine. The build-up of carbon around the piston rings of a reciprocating engine will result in reduced mobility of the piston rings, poor sealing between the rings and the cylinders, loss of compression with the resulting loss of power and efficiency, and increased blow-by of gases past the piston rings and into the crankcase, causing contamination and eventual failure of the engine lubricants. The current methods for removal of that carbon require disassembly of the engine and manual scraping of the carbon, which is expensive and time consuming.

Carbon also accumulates in the combustion chambers and exhaust flues of any apparatus that combusts a fuel, including furnaces, ovens and boilers. Manual removal of the carbon by scraping is a regular item of maintenance for combustion appliances.

Hydrogenation of solid coal to form liquid hydrocarbons is known for the production of oil and lubricants. See the Wikipedia article, “Coal Liquefaction” accessed Aug. 5, 2014. The known hydrogenation of coal is a process that occurs at elevated temperatures and pressures.

### III. BRIEF DESCRIPTION OF THE INVENTION

The Invention is an apparatus and method for the prevention of the build-up of carbon and for the removal of carbon, such as carbon soot trapped by a particulate filter of a diesel truck engine, carbon deposits on pistons and piston rings of an engine, or carbon deposits or build-up on any combustion apparatus. The apparatus and method of the invention involve hydrogenating the carbon by exposing the parts to be cleaned to hydrogen gas (H₂). When elemental carbon (such as the carbon trapped in the diesel particulate filter or carbon deposits on piston rings) is exposed to hydrogen gas, the hydrogen reacts chemically with the carbon, converting the carbon to a variety of hydrocarbons, which may be in a liquid or gaseous state. In other words, exposure of the carbon to hydrogen converts the carbon to oil and to gaseous hydrocarbons. The resulting oil may then be removed manually as a liquid or by combusting the oil.

The first step is to obtain a source of hydrogen. While compressed elemental hydrogen gas may be used, oxyhydrogen, or HHO, also may supply the hydrogen. HHO is a stoichiometric mixture of hydrogen (H₂) and oxygen (O₂) generated by the dissociation of water through electrolysis. The HHO may be generated using the HHO generator described in U.S. Pat. No. 8,852,410, ‘Electrolytic hydrogen generator and method,’ issued Oct. 7, 2014 to Luke J. Turgeon et al. The electrical power supply for the HHO generator may be the reciprocating engine itself, and will utilize about one or two horsepower produced by the engine to generate the HHO. Any suitable source may act as the electrical power supply for the HHO generator, including electricity provided by the electric power industry.

Where the apparatus to be cleaned is a particulate filter from a diesel truck, the filter may be cleaned in place. The particulate filter is a component of the exhaust system of the diesel engine. For cleaning the particulate filter in place, HHO is introduced into the exhaust gas stream of the diesel engine on the intake side of the filter, as by injecting the HHO through a port, while the engine is running The temperature of the exhaust gas and of the particulate filter is below the ignition temperature of the HHO. As a result, the HHO does not ignite in the particulate filter and does incinerate the solid carbon. Instead, the HHO converts the carbon to liquid and gaseous hydrocarbons by hydrogenation. The oil and gaseous hydrocarbons then may be combusted in the catalytic converter.

Even though hydrogenation is exothermic, the process of hydrogenation of the solid carbon in the particulate filter to liquid or gaseous hydrocarbons is a cold process; namely, the temperature of the exhaust gas, the HHO and the particulate filter does not increase significantly during the reaction. As a result, the ceramic core, seals and other components of the particulate filter are not subject to the thermal stresses or physical violence of conventional regeneration, avoiding damage to the structure of the particulate filter and extending the service life of the filter.

For cleaning a particulate filter that has been removed from the exhaust system of the diesel engine, air is blown through the filter and the HHO is introduced into the air stream prior to the filter. The HHO converts the carbon soot to oil and gaseous hydrocarbons, which are drained or washed from the filter or combusted in the catalytic converter when the filter is re-installed in the exhaust system.

Where the apparatus to be cleaned comprises the internal parts of a reciprocating engine, such as the pistons and rings of a diesel or gasoline engine, HHO is introduced on the intake side of the engine while the engine is running If the engine is turbocharged, the HHO may be introduced either before or after the turbocharger compressor.

Conventional turbocharger compressors generally are constructed of aluminum, which is subject to embrittlement by exposure to hydrogen gas. As a result, injection of the HHO after the turbocharger compressor is preferable to avoid damage to the compressor. The HHO must be injected at a suitably high pressure to overcome the pressure created by the turbocharger compressor. The HHO generator of U.S. Pat. No. 8,852,410, incorporated by reference, may supply HHO of 100 psi, substantially more than the pressure produced by a turbocharger compressor, and has proven suitable in practice.

When HHO is introduced to the intake of the running engine, the HHO enters the combustion chamber on the intake stroke at a relatively low temperature and is compressed along with the fuel and air mixture to an increased temperature and pressure. The increased temperature and pressure of the hydrogen in the cylinder prior to ignition promotes the reaction of the hydrogen with the carbon deposits on the pistons and rings, turning the carbon deposits to oil and to gaseous hydrocarbons, which then are consumed by the engine or blown past the rings into the crankcase. Introduction of HHO into the intake of the engine may be sufficient to clean carbon from the particulate filter in the exhaust system as well.

Introduction of the HHO into the intake of the engine also serves to reduce particulate emissions from the engine by providing more complete combustion of the fuel and controls NOx emissions from the engine by providing hydrogen to reduce the NOx to N₂ and H₂O, which the inventors have confirmed experimentally, as discussed below.

The Invention can be used for the subtractive shaping of carbon, such as the shaping of carbon electrodes. A jet of H₂ or HHO may be used for the reductive shaping of a carbon work piece to any desired physical shape without physically touching the carbon work piece with a solid tool (such as a cutter of a milling machine or lathe) or liquid tool (such as a water jet) and without generating heat. The carbon may be shaped to any desired shape, including shapes too delicate to be achieved by use of a solid or liquid cutting tool.

A similar injection of H₂ or HHO serves to remove carbon deposits from any location, such as the inside of a stove, furnace or boiler.

Because the HHO generator may be mounted to the truck and may move with the truck, the HHO generator may provide HHO constantly whenever power is provided to the HHO generator, as when the diesel engine is operating. HHO may be injected continuously into the diesel engine exhaust gas upstream from the particulate filter to continuously clean solid carbon from the particulate filter to avoid accumulation of particulate matter in the filter. Continuously cleaning the solid carbon from the filter prevents an increase in the pressure drop across the filter and prevents efficiency losses in the diesel engine due to increased backpressure on the engine exhaust ports. Continuous injection of the HHO into the exhaust gas stream either upstream or downstream of the particulate filter allows continuous reaction between the hydrogen in the HHO and the NOx in the exhaust gas to reduce NOx to N₂ and H₂O. The inventor believes that continuous injection of HHO into the exhaust gas will allow elimination of urea injection for diesel trucks.

Alternatively, injection of HHO may be selectable between different locations in the exhaust system of the diesel engine and the intake to the engine and may be episodic or periodic. In this instance, HHO may be directed to the particulate filter if the particulate filter needs cleaning, to the exhaust gas downstream of the particulate filter to control NOx or to the intake side of the diesel engine to clean carbon from the engine internal components or to improve combustion efficiency, all as determined by the user or under the control of a control system. The direction of HHO to the components to be cleaned may be on a pre-determined schedule.

As another alternative, HHO may be injected to a plurality of locations on the diesel engine intake and exhaust system simultaneously, for example, to the intake of the engine after the turbocharger compressor to increase combustion efficiency and to prevent carbon deposits, to the upstream side of the particulate filter to prevent carbon deposits, and to the downstream side of the particulate filter to reduce NOx to N₂ and H₂O. The amount of HHO sent to each location may be appropriately metered to accomplish each task.

### IV. BRIEF DESCRIPTION OF THE DRAWINGS

FIG. 1 is a schematic diagram of a diesel engine with a particulate filter, urea injection, a catalytic converter and HHO injection.

FIG. 2 is a schematic diagram of a diesel engine with HHO injection prior to the particulate filter.

FIG. 3 is a schematic diagram of a diesel engine with HHO injection prior to the catalytic converter.

FIG. 4 is a flow chart of a method for cleaning a particulate filter installed in an exhaust system.

FIG. 5 is a flow chart of a method for controlling emissions of NOx from a diesel engine.

FIG. 6 is a schematic diagram of a diesel engine with HHO injection on the high-pressure side of the turbocharger.

FIG. 7 is a schematic diagram of a diesel engine with HHO injection on the low-pressure side of the turbocharger.

FIG. 8 is a flow chart of a method cleaning carbon from internal components of an engine.

FIG. 9 is a photograph of a jet of HHO converting carbon deposits to oil on the crown of a piston.

FIG. 10 is a schematic diagram of a diesel engine with HHO injection at multiple locations.

FIG. 11 is a schematic diagram of an apparatus for cleaning a particulate filter.

FIG. 12 is a flow chart of a method for cleaning a particulate filter that is not installed in an exhaust system.

FIG. 13 is a schematic diagram of a diesel engine in which the catalytic converter and particulate filter are incorporated into a single unit.

FIG. 14 is a chart of normalized exhaust gas characteristics of a diesel engine into which HHO is injected for portions of the period of the test.

FIG. 15 is a schematic diagram of the shaping of a carbon work piece by the hydrogen in HHO.

FIG. 16 is a method of shaping a carbon work piece using HHO.

### V. DETAILED DESCRIPTION OF AN EMBODIMENT

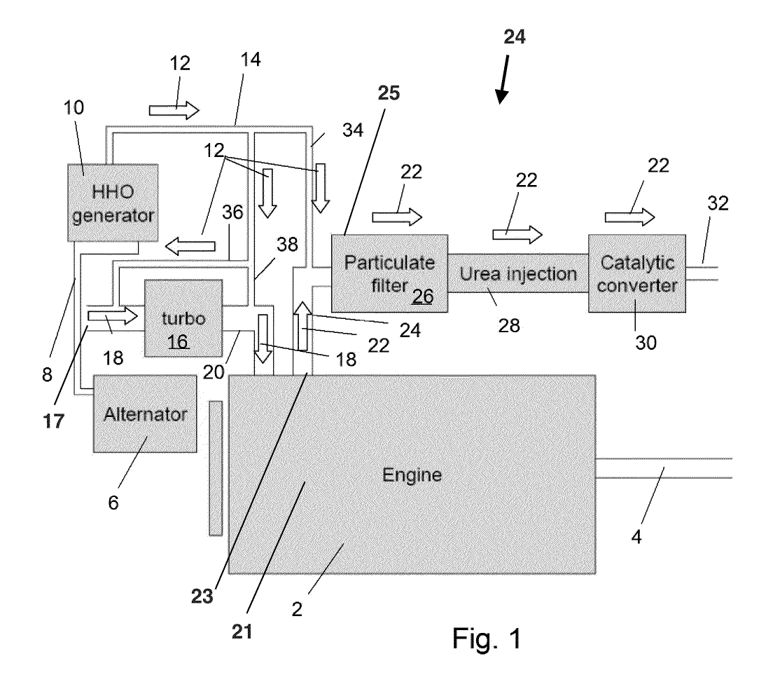

FIG. 1 illustrates power producing apparatus, such as a reciprocating internal combustion engine 2 that may be a diesel engine 2, with HHO generation and different locations for HHO injection. The diesel engine 2 rotates an output 4 which may provide motive power for a motor vehicle or for any other application. The engine 2 also drives an alternator 6 that generates electrical power that travels through wires 8 to HHO generator 10. HHO generator 10 generates HHO 12 as described in U.S. Pat. No. 8,852,410, ‘Electrolytic hydrogen generator and method’ issued to Luke J. Turgeon, et al. on Oct. 7, 2014. Piping 14 conveys the HHO 12.

The example engine 2 is illustrated as being equipped with a turbocharger compressor 16, but the invention also applies to non-turbocharged engines 2 and to supercharged engines 2. Intake air 18 on a low-pressure side of the turbocharger compressor 16 at an intake 17 of the diesel engine 2 is compressed by turbocharger compressor 16 and conveyed from the high-pressure side 20 of the turbocharger compressor 16 into the engine 2. The intake air 18 is further compressed within a cylinder 21 of the engine 2 to a pressure and temperature above the spontaneous combustion point for droplets of the liquid fuel. The liquid fuel (e.g. diesel fuel) is injected at high pressure in a fine mist of droplets into the cylinder. The outside surfaces of the droplets begin spontaneously combusting and burn from the outside inward, since only the outside surface is exposed to oxygen, with combustion continuing in an onion-peel fashion.

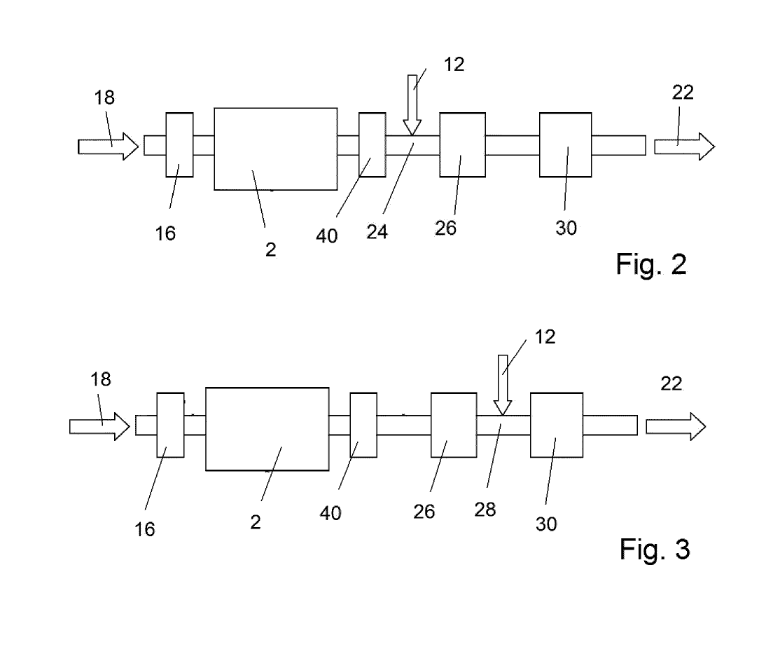

Exhaust gas 22 is discharged from exhaust port 23 and travels through an exhaust system 24. Exhaust system 24 may include a particulate filter 26, urea injection duct 28 and a catalytic converter 30. Exhaust system 24 also may include a conventional turbocharger impeller 40 (FIG. 2). Particulate matter, which is principally solid carbon in the form of carbon soot, is collected in the particulate filter 26. The exhaust gas 22 passes from particulate filter 26 and into the urea injection duct 28. In the urea injection duct 28, urea is injected into the exhaust gas stream 22. The urea decomposes into ammonia. The mixture of exhaust gas 22 and urea (now ammonia) enters the catalytic converter 30, in which the hydrogen in the ammonia reacts with NOx in the exhaust gas stream 22, chemically reducing the NOx to form nitrogen gas and water. The exhaust gas 22, with lowered levels of particulate matter and NOx, is discharged through exhaust pipe 32.

The HHO 12 is discharged from the HHO generator 10 upstream of an object to be cleaned of solid carbon. The object to be cleaned may be an exhaust system component to be cleaned 25. FIG. 1 illustrates three locations for HHO 12 injection. The first location is through a particulate filter injection duct 34, through which HHO 12 may be injected into the exhaust system 24 upstream from the particulate filter 26. In this instance, the particulate filter 26 is the exhaust system component to be cleaned 25 and discharge of HHO 12 through the particulate filter injection duct 34 provides HHO 12 for the cleaning of the particulate filter 26. The HHO 12 is discharged through the particulate filter 26 at a sufficient rate of flow and for a sufficient period of time to hydrogenate the solid carbon trapped in the particulate filter 26 into liquid and gaseous hydrocarbons, thereby cleaning the solid carbon from the particulate filter 26.

The HHO 12 may be discharged through the particulate filter 26 substantially continuously when the engine 2 is running to keep the particulate filter 26 clear of solid carbon. Alternately, HHO 12 may be discharged through the particulate filter 26 periodically or as needed to remove solid carbon from the particulate filter 26.

The exhaust gas 22, the HHO 12 and the exhaust system component to be cleaned 25 are maintained below the ignition temperature of the HHO 12 when HHO 12 is discharged to the exhaust system component to be cleaned 25 so that the HHO 12 does not combust in the exhaust system component to be cleaned 25. If the HHO 12 combusts, the hydrogen in the HHO 12 is no longer available for hydrogenation of the solid carbon and the HHO 12 is ineffective for cleaning solid carbon.

The inventors believe that a diesel engine 2 equipped with HHO 12 injection into the exhaust system 24 upstream of the particulate filter 26 will be able to maintain the particulate filter 26 in a compliant condition and will not require regeneration or service by soot blowing, heating in a kiln, or replacement of the particulate filter 26.

The second location for HHO 12 injection is through a turbocharger low-pressure side injection duct 36 to the low-pressure side of the turbocharger 16. The third location for HHO 12 injection is through a turbocharger high-pressure injection duct 38 into the turbocharger duct 20 on the high-pressure side of the turbocharger 16. For both of the second and third locations, the HHO 12 enters the cylinders of the engine 2 along with the intake air 18. The HHO 12 is compressed and heated within the cylinder 21 of the diesel engine 2 and exposed to solid carbon that has accumulated within the cylinder 21 and on and around the piston rings and on the interior of the engine 2. The heated, high-pressure hydrogen gas in the HHO 12 reacts with the solid carbon, hydrogenating the solid carbon and converting the solid carbon to hydrocarbon oil and gaseous hydrocarbons, which are combusted in the cylinder 21 or blown past the piston rings into the crankcase. The engine 2 is thus cleaned of solid carbon deposits and oil and gaseous hydrocarbons serve to provide fuel for the engine 2.

An engine 2 may be equipped for HHO 12 injection at any or all of the locations shown by FIGS. 1, 2, 3, 6, 7, 10, 11 and 13 including upstream of the particulate filter 26, upstream of the catalytic converter 30 in the urea injection area 28, upstream of a combination particulate filter 26 and catalytic converter 30, in the intake air 18 upstream of the turbocharger compressor 16, and to the compressed intake air 18 downstream of the turbocharger compressor 16. The discharge may be selectable so that an operator or a control system may select to which of the plurality of discharge locations the HHO 12 is discharged. The HHO generator 10 may be configured to discharge HHO 12 to more than one discharge location simultaneously. The discharge locations may be selected automatically on a timed schedule or may be based on the results of sensors, for example a sensor detecting a pressure drop across the particulate filter 26, a sensor detecting elevated NOx emissions or sensors detecting a drop in power output of the diesel engine 2 or an increase in diesel fuel usage. Any combination of injection locations is contemplated by the invention. The HHO generator 10 may be configured to discharge HHO 12 to the selected discharge locations substantially continuously when the diesel engine 2 is running and may discharge HHO 12 substantially continuously to the exhaust system 24 upstream of the particulate filter 26.

Where the discharge of HHO 12 is to the exhaust system 24 or to the high-pressure side 20 of the turbocharger compressor 16, the HHO generator 10 will supply HHO 12 at a pressure sufficient to overcome the maximum pressure of the intake air 18 or the exhaust gas 22 at those locations.

FIG. 2 is another schematic diagram of the injection of HHO 12 prior to the particulate filter 26. Intake air 18 enters the engine 2 through the turbocharger compressor 16 and exhaust gas 22 passes from the engine 2 and through the turbocharger impeller 40, particulate filter 26, urea injection duct 28, and catalytic converter 30. In the example of FIG. 2, HHO 12 is injected into the exhaust gas stream 22 in the exhaust system 24 upstream of the particulate filter 26, to allow the HHO 12 to react with the carbon in the filter 26 and to maintain the filter 26 in a clean condition.

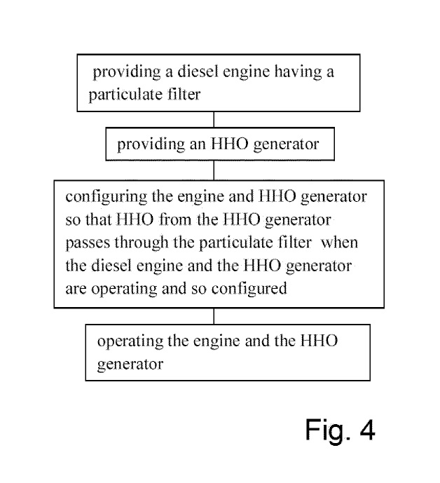

FIG. 3 illustrates injection of the HHO 12 into the urea injection duct 28 to assist in the chemical reduction of NOx in the exhaust gas 22. In the instance of FIG. 3, the injected HHO 12 may provide adequate hydrogen for chemical reduction of the NOx in the exhaust gas 22 so that the injection of urea to control NOx can be reduced or eliminated.

The injection of HHO 12 derived from water has advantages over the injection of urea for the control of NOx. Because water contains more hydrogen than urea per unit mass and volume, a truck equipped with a diesel engine, HHO generation and injection of HHO for NOx control can go farther on one gallon of water than an otherwise identical truck with urea injection for NOx control can go on one gallon of urea solution.

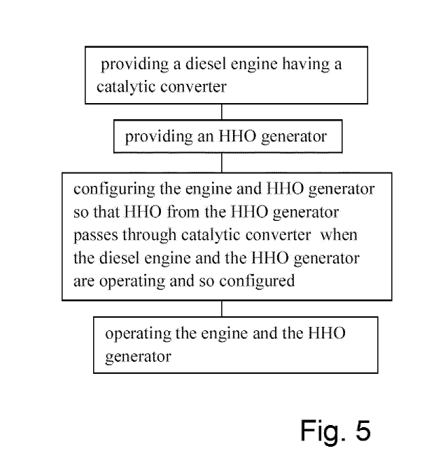

FIG. 4 is a flow chart of a method corresponding to the apparatus of FIG. 2. The method of FIG. 4 illustrates cleaning the particulate filter 26 of a diesel engine 2 when the particulate filter 26 is in place as part of the exhaust system 24 of the diesel engine 2. The diesel engine 2 and the HHO generator 10 operate at the same time and the HHO 12 is injected into the exhaust gas 22 from the diesel engine 2 before the particulate filter 26. The HHO 12 hydrogenates the carbon trapped in the particulate filter 26, converting the solid carbon into oil and gaseous hydrocarbons, thus cleaning the particulate filter 26. The HHO generator 10 may be powered by the engine 2, as illustrated by FIG. 1, or may be separate from the engine 2 and driven by, for example, electricity provided by the electric power industry.

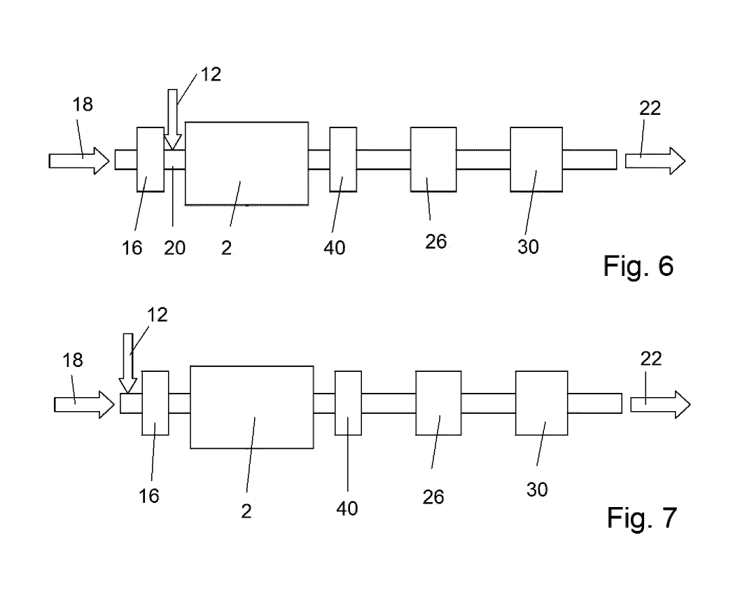

FIG. 5 describes a method corresponding to the apparatus of FIG. 3. The method of FIG. 5 is a process for reducing or eliminating the use of urea for controlling NOx emissions in the exhaust 22 of a diesel engine 2. When the engine is running, HHO 12 from an HHO generator 10 is injected into the exhaust gas stream 22 ahead of the catalytic converter 30. The injection of HHO 12 provides an alternative to urea as a source for hydrogen for the chemical reduction of NOx. The hydrogen gas in the HHO 12 chemically reduces the NOx to N₂ and H₂O in the catalytic converter, lowering the amount of NOx in the exhaust gas 22 and lowering the amount of urea required to control NOx emissions, or eliminating the requirement for urea altogether. The HHO generator may be powered by the engine 2, as illustrated by FIG. 1.

If HHO 12 is injected in the exhaust system 24 upstream of the particulate filter 26 (FIGS. 2 and 4), injection of HHO 12 into the urea injection duct 28 (FIGS. 3 and 5) may not be necessary and the HHO 12 injected upstream of the particulate filter 26 may be sufficient to achieve adequate NOx reduction. Injection of HHO 12 at other locations may allow urea injection to be cut or to be eliminated completely.

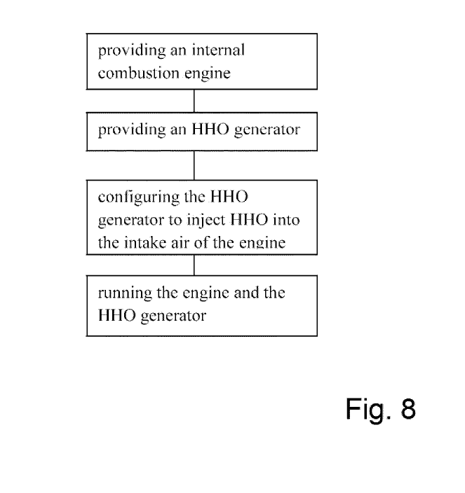

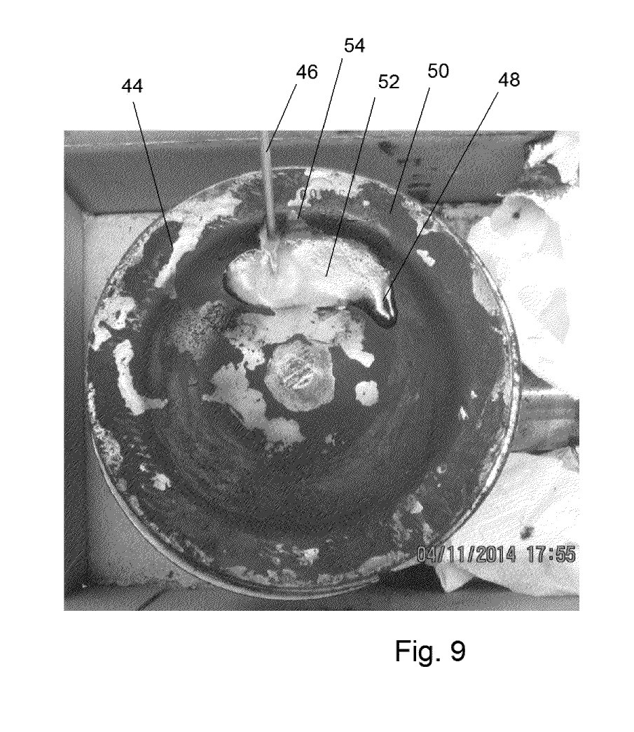

FIGS. 6 and 7 illustrate injection of HHO 12 into the high-pressure side and the low-pressure side of the turbocharger 16, respectively. As noted, both the arrangements of FIGS. 6 and 7 will provide for carbon cleaning from the area of the combustion chamber of the engine 2, including the cylinders 21 and pistons.

Injection of HHO on the high-pressure side 20 of the turbocharger compressor 16 as shown by FIG. 6 requires a high-pressure source of HHO, such as the HHO generator taught by U.S. Pat. No. 8,852,410, ‘Electrolytic hydrogen generator and method’ issued to Luke J. Turgeon, et al. on Oct. 7, 2014, incorporated by reference herein and rated for HHO delivery at 100 psi. Injection of HHO on the high-pressure side 20 of the turbocharger compressor 16 has the advantage of avoiding any damage to the turbocharger compressor 16 from the hydrogen gas in the HHO 12, which reacts with most metals, including the soft aluminum that may be used to construct the turbocharger compressor 16.

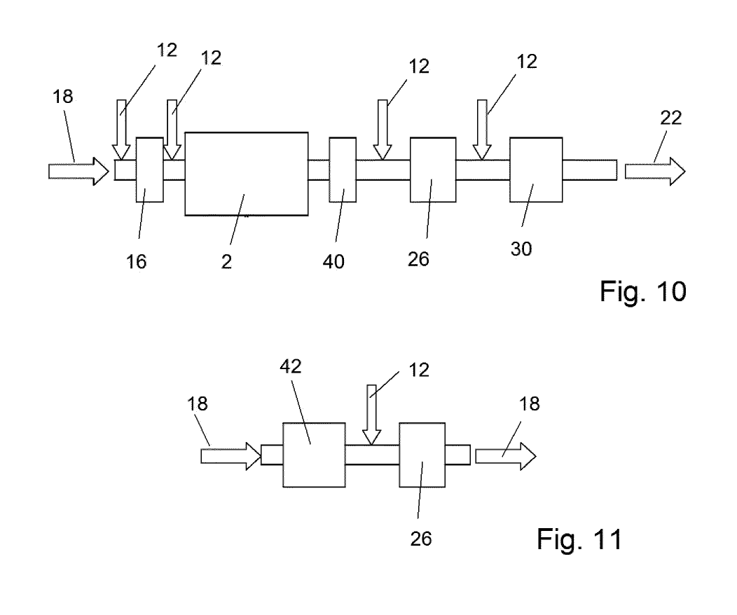

FIG. 8 is a method for cleaning carbon from the internal parts of the engine 2 corresponding to the apparatus of FIGS. 6 and 7. HHO 12 is introduced into the intake air 18 of the engine 2 on either the low-pressure or high-pressure side 20 of the turbocharger compressor 16 when the engine 2 is running The hydrogen in the HHO 12 hydrogenates the carbon deposits on the internal engine parts, converting the carbon into liquid and gaseous hydrocarbons and cleaning the carbon deposits from the internal parts.

The method of FIG. 8 applies equally to prevention of solid carbon buildup in or cleaning carbon from a gasoline (Otto cycle) engine 2. The HHO 12 is injected into the intake air 18 of the gasoline engine 2, which hydrogenates the carbon on the internal engine parts, cleaning the internal engine parts and preventing buildup of carbon on those parts.

The HHO 12 injection options of FIGS. 6 and 7 contemplate, but do not require, an HHO generator 10 powered by the engine 2. In particular, the injection of HHO 12 illustrated by FIGS. 6 and 7 allows cleaning of carbon from an engine 2 that is not equipped for HHO 12 generation. For example, a service shop that has a supply of bottled hydrogen or that has an HHO generator 10 that is driven by electricity provided by the electric power industry or by a power supply other than the engine 2 may inject HHO 12 into the low pressure side of the turbocharger compressor 16 and run the engine 2, thus cleaning carbon from the engine 2.

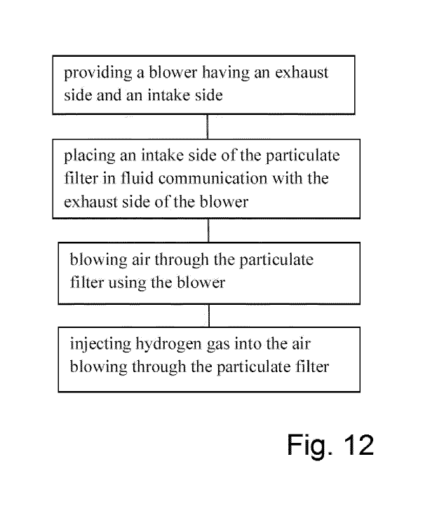

FIG. 9 is a photograph of an experiment conducted by the inventors to demonstrate the cleaning of carbon from a piston 44 at room temperature and ambient air pressure. HHO 12 is discharged through tube 46. Some water vapor escaped from the HHO generator 10, which is the source of the HHO 12, and condensed to liquid water 48 on the crown of the piston 44. Solid carbon deposits 50, when exposed to the HHO 12, were hydrogenated and converted to oil and gaseous hydrocarbons. The oil is shown in FIG. 9 as in an emulsion 52 with the water 48. A previously cleaned area is illustrated by location 54 on piston 44. The inventors believe that the observed conversion of solid carbon to oil and gaseous hydrocarbons at room temperature and pressure will be accelerated at higher temperatures and pressures, such as the temperatures and pressures existing within the cylinder 21 of a diesel or gasoline engine 2 during compression of the fuel/air mixture and prior to ignition.

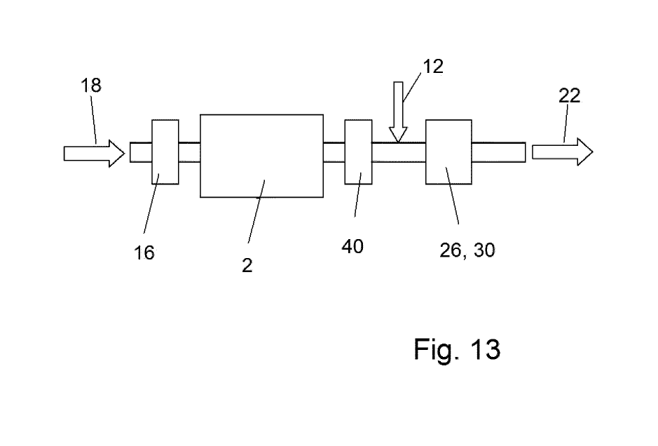

FIG. 10 illustrates several locations at which HHO 12 may be injected into the intake air 18 and the exhaust gas 22 of the engine 2. Those locations include into the intake air 18 on the low-pressure side of the turbocharger 16, into the intake air 18 on the high-pressure side 20 of the turbocharger 16, into the exhaust gas 22 upstream of the particulate filter 26 and into the exhaust gas 22 upstream of the catalytic converter 30. HHO 12 may injected at any or all of these locations on the running engine 2.

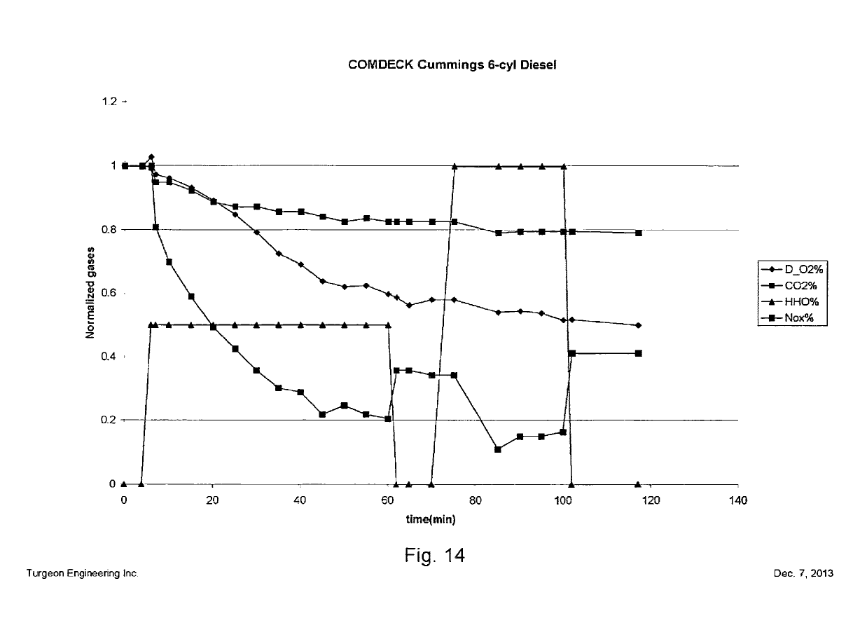

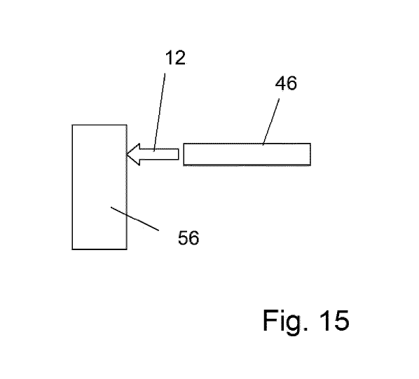

FIG. 11 illustrates an apparatus for cleaning carbon from a particulate filter 26 that is removed from the exhaust system of the engine 2. FIG. 12 illustrates a method corresponding to FIG. 11.

From FIG. 11, a blower 42 forces ambient air 18 through the particulate filter 26. HHO 12 is injected into the duct from the blower 42 to the particulate filter 26. The hydrogen in the HHO 12 reacts with the carbon clogging the particulate filter 26, hydrogenating the carbon and forming liquid and gaseous hydrocarbons, thus cleaning the solid carbon from the filter. The high-pressure side of a shop vacuum has proven suitable for blower 42. Alternatively, the HHO 12 may be injected on the low-pressure side of blower 42.

For the method of FIG. 12, a blower 42 has an intake and exhaust side. The intake side of the particulate filter 26 is placed in fluid communication with the exhaust side of the blower 42 and ambient air 18 is blown through the particulate filter 26. HHO 12 is introduced into the ambient air 18 that will pass through the filter 26 by injecting the HHO 12 either into the intake side of the blower 42 or into the duct connecting the exhaust side of the blower 42 with the filter 26. The HHO 12 hydrogenates the carbon in the filter 26, cleaning the filter 26.

Using the apparatus of FIG. 11 and method of FIG. 12, the inventors conducted an experiment to determine whether carbon can be removed from a modern diesel engine 2 particulate filter 26 using HHO 12 at room temperature and pressure. The particulate filter 26 was removed from the exhaust system of the engine 2 and the pressure drop across the particulate filter 26 was measured. A flow of air 18 was initiated through the particulate filter 26 using the positive pressure side of a shop vacuum as a blower 42. HHO 12 from an HHO generator 10 was injected into the flow of air 18 from the blower 42 and into the filter 26. The HHO generator 10 was as described in U.S. Pat. No. 8,852,410, ‘Electrolytic hydrogen generator and method’ issued to Luke J. Turgeon, et al. on Oct. 7, 2014, incorporated by reference herein. The HHO generator 10 and blower 42 were allowed to run for a period of about three hours. The pressure drop across the particulate filter 26 was again measured and showed about a 2.3% reduction in the pressure drop across the filter 26. The particular filter 26 that was cleaned during the experiment was not clogged and did not require cleaning. The inventors expect a greater percentage reduction in back pressure in particulate filters 26 that are in need of cleaning

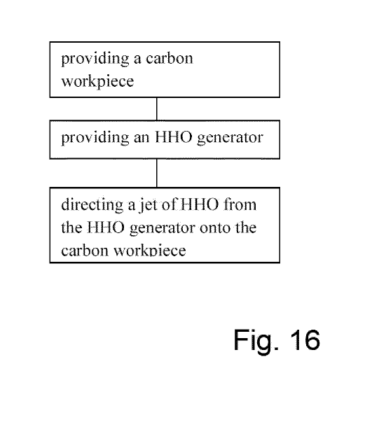

FIG. 13 illustrates an alternative engine 2 apparatus. In FIG. 13, the particulate filter 26 and catalytic converter 30 are incorporated into a single unit, which is possible because injection of the HHO 12 prior to the particulate filter 26 cleans carbon from the particulate filter 26 as the carbon is trapped by the filter 26 and avoids service or replacement of the particulate filter 26 due to clogging.

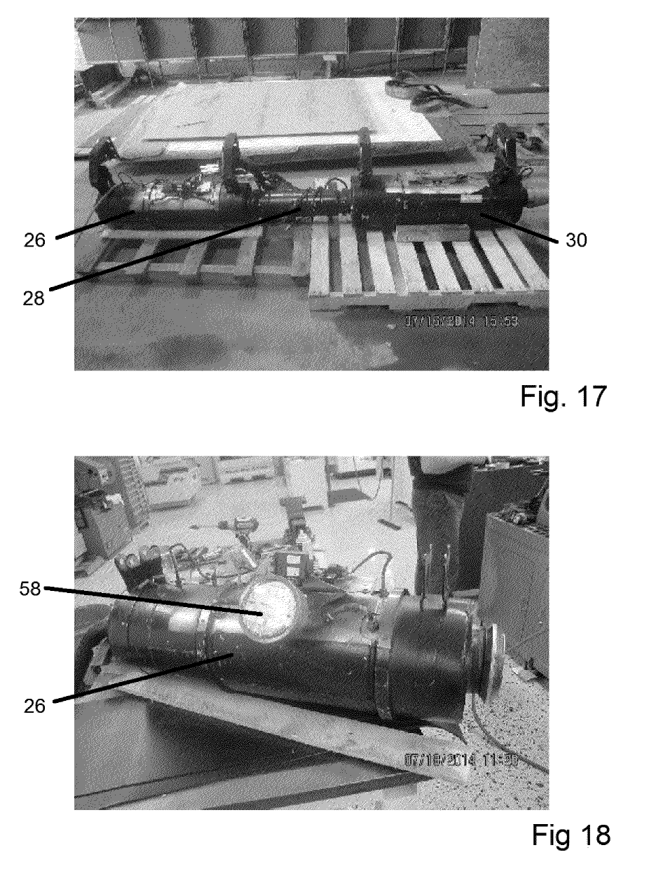

FIG. 14 is a chart of the results of a test of a diesel engine 2 measuring normalized exhaust gas 22 characteristics. The diesel engine 2 was not equipped with a particulate filter 26, urea injection 28 or catalytic converter 30. HHO 12 was injected into the intake air 18. During the period of time that HHO 12 was injected, emissions of NOx decreased substantially below the levels of NOx emissions when HHO 12 was not injected. The inventors believe that injection of HHO 12 at one or more locations in the intake or exhaust gas streams 18, 22 will achieve sufficient decrease in NOx in the exhaust gas 22 to reduce or avoid the need for urea injection and to reduce or avoid the need for a catalytic converter 30.

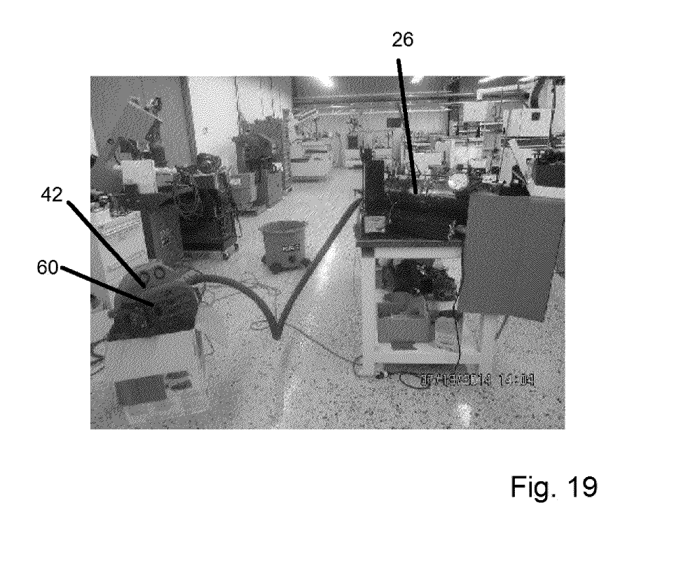

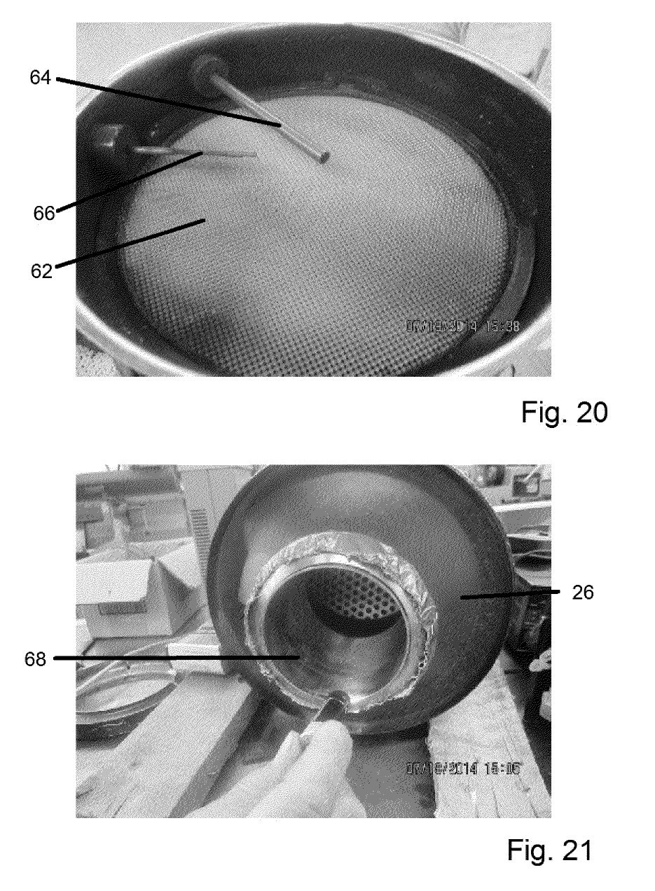

FIGS. 15 and 16 illustrate the reductive shaping of a carbon work piece 56, such as a carbon electrode, using HHO 12. FIG. 15 illustrates the apparatus and FIG. 16 illustrates the method. The HHO 12 is conveyed through a tube 46 and a jet of HHO 12 is directed to the location on the carbon work piece 56 from which material is desired to be removed. The jet of HHO 12 locally hydrogenates the carbon work piece 56, converting the carbon to liquid and to gaseous hydrocarbons. The jet of HHO 12 thus changes the shape of the carbon work piece 56 without touching the work piece 56 with a solid or liquid tool, such as a cutter of a milling machine or a water jet. The inventors believe that a carbon work piece 56 in any form, such as the mineral diamond, may be shaped in this fashion.

### LIST OF NUMBERED ELEMENTS

The following numbered elements are illustrated by the drawings and discussed in the detailed description of an embodiment.
Power producing apparatus, reciprocating internal combustion engine, diesel engine 2
engine output 4
alternator 6 wires 8
HHO generator 10
HHO 12
HHO piping 14
turbocharger compressor 16
intake 17
Intake air 18
high-pressure side 20
cylinder 21
Exhaust gas 22
exhaust port 23
exhaust system 24
exhaust system component to be cleaned 25
a particulate filter 26,
urea injection duct 28
catalytic converter 30
exhaust pipe 32.
particulate filter injection duct 34
through a turbocharger low-pressure side injection duct 36
a turbocharger high-pressure injection duct 38
turbocharger impeller 40
blower 42
piston 44
tube 46
liquid water 48
Solid carbon deposits 50
emulsion 52
previously cleaned location 54
carbon work piece 56

I claim:

1. A method for controlling solid carbon in a reciprocating engine, the method comprising the steps of:
a. providing that the reciprocating engine is configured to discharge an exhaust gas from an exhaust port through an exhaust system;
b. providing an HHO generator configured to inject HHO into said exhaust gas in the exhaust system downstream of said exhaust port of said reciprocating engine and upstream of an exhaust system component to be cleaned;
c. operating said reciprocating engine;
d. injecting HHO from said HHO generator into said exhaust gas of the operating reciprocating engine at a sufficient rate of flow and for a sufficient period of time to hydrogenate the solid carbon to liquid or gaseous hydrocarbons, whereby hydrogenation of the solid carbon cleans the solid carbon from said exhaust system component to be cleaned.

2. The method of claim 2 wherein said step of injecting said HHO into the exhaust gas includes: maintaining said HHO at a temperature below an ignition temperature of the HHO while the HHO passes through said exhaust system component to be cleaned, whereby said HHO does not combust in said exhaust system component to be cleaned.

3. The method of claim 2 wherein the reciprocating engine is a diesel engine and said exhaust system component to be cleaned is a particulate filter.

4. The method of claim 3 wherein said diesel engine is located on a motor vehicle, said HHO generator is on board said motor vehicle, and said HHO generator is powered by said diesel engine.

5. The method of claim 4, the method further comprising: incinerating said liquid and gaseous hydrocarbons in a catalytic converter located downstream of said particulate filter.

6. The method of claim 4 wherein said configuration of said HHO generator to discharge HHO into said exhaust gas is selectable, said HHO generator also being configured to selectably inject said HHO downstream of said particulate filter and upstream of a catalytic converter to clean solid carbon from said catalytic converter by hydrogenating the solid carbon to liquid or gaseous hydrocarbons.

7. The method of claim 4 wherein said configuration of said HHO generator to discharge HHO into said exhaust gas is selectable, said HHO generator also being configured to selectably inject said HHO into an intake air of said engine, the method further comprising: injecting said HHO selectably into said intake air whereby said HHO will clean the solid carbon from an interior of said engine by hydrogenation of the solid carbon to said liquid or gaseous hydrocarbons.

8. The method of claim 7 wherein said diesel engine includes a turbocharger compressor to compress said intake air entering said diesel engine and wherein said step of selectably injecting said HHO into said intake air comprising: injecting said HHO downstream of said turbocharger and upstream of a cylinder of the said diesel engine at a pressure sufficient to overcome a pressure of said intake air compressed by said turbocharger, whereby injection of said HHO into said intake air occurs after said turbocharger compressor to avoid embrittlement of said turbocharger compressor.

9. The method of claim 4 wherein said step of discharging said HHO downstream of said exhaust port and upstream of said particulate filter occurs substantially continuously during operation of said diesel engine.

10. The method of claim 4 wherein said step of claim 4 wherein said HHO generator is configured to discharge said HHO at a sufficient pressure to overcome a maximum pressure of said exhaust gas in said exhaust system at a location of discharge of said HHO into said exhaust gas.

11. A power-producing apparatus, the power-producing apparatus comprising:
a. a diesel engine, said diesel engine having an exhaust port, said diesel engine configured to generate an exhaust gas when said diesel engine is running and to exhaust said exhaust gas through said exhaust port;
b. an exhaust system including an exhaust system component to be cleaned, said exhaust system is configured to convey said exhaust gas from said exhaust port and through said exhaust system component to be cleaned when said diesel engine is running;
c. an HHO generator configured to generate an HHO, said HHO generator configured to discharge said HHO into said exhaust system downstream from said exhaust port and upstream of said exhaust system component to be cleaned when said diesel engine is running and said exhaust system is conveying said exhaust gas, whereby a hydrogen in said HHO will hydrogenate a solid carbon in said exhaust system component to be cleaned to liquid or gaseous hydrocarbons and thereby remove said solid carbon from said exhaust system component to be cleaned when said diesel engine is running and said HHO is discharged into said exhaust system.

12. The apparatus of claim 11 wherein said exhaust system is configured so that said HHO does not exceed an ignition temperature of said HHO when said HHO is discharged into said exhaust system and while said HHO passes through said exhaust system component to be cleaned, whereby said HHO does not combust in said exhaust system component to be cleaned.

13. The apparatus of claims 12 wherein said exhaust system component to be cleaned is a particulate filter.

14. The apparatus of claim 13, the apparatus further comprising: a motor vehicle, said diesel engine and said HHO generator are mounted to said motor vehicle, said HHO generator is powered by said diesel engine.

15. The apparatus of claim 13 wherein said HHO generator is configured to discharge said HHO into said exhaust system substantially continuously when said diesel engine is running, whereby said HHO cleans solid carbon from said particulate filter substantially continuously.

16. The apparatus of claim 13 wherein said HHO generator is configured to selectably discharge said HHO into said exhaust system, said HHO generator also is configured to selectably discharge said HHO into an intake of said diesel engine, whereby said HHO may be directed to said diesel engine intake to hydrogenate solid carbon within said diesel engine to liquid or gaseous hydrocarbons.

17. The apparatus of claim 13 wherein said HHO generator is configured to selectably discharge said HHO to a plurality of selectable locations on an intake of said diesel engine and in said exhaust system of said diesel engine to hydrogenate solid carbon to liquid or gaseous hydrocarbons at said selectable locations.

18. A method of cleaning solid carbon from an object to be cleaned, the method comprising the steps of:
a. providing an HHO generator;
b. exposing a component to be cleaned to an HHO from said HHO generator at a temperature below an ignition temperature of said HHO, whereby hydrogen in said HHO hydrogenates the solid carbon to liquid or to gaseous hydrocarbons to clean the solid carbon from the component to be cleaned and whereby said HHO is no combusted during cleaning of the solid carbon from the component to be cleaned.

19. The method of claim 18 wherein the component to be cleaned is a particulate filter for a diesel engine, the method further comprising:
a. blowing an air through said particulate filter when said particulate filter is removed from an exhaust system of a diesel engine;
b. injecting HHO into said air blowing through said particulate filter.

20. The method of claim 19 wherein said step of injecting HHO into said air further comprises: maintaining a sufficient flow of said HHO for a sufficient period of time to adequately clean said solid carbon from said particulate filter.
